(19) United States
(12) Patent Application Publication
(10) Pub. No.: US 2008/0057150 A1
(43) Pub. Date: Mar. 6, 2008

(54) COMPOSITE PRODUCTION BY RESIN TRANSFER MOLDING

(75) Inventor: Alan Roger Harper, Cornwall (GB)

Correspondence Address: LARSON AND LARSON, 11199 69TH STREET NORTH, LARGO, FL, 33773, US

(73) Assignee: GRAVES SPRAY SUPPLY, INC., Clearwater, FL (US)

(21) Appl. No.: 11/621,292

(22) Filed: Jan. 9, 2007

Related U.S. Application Data
(63) Continuation-in-part of application No. PCT/GB2004/005178, filed on Dec. 9, 2004.

(30) Foreign Application Priority Data
Dec. 9, 2003 (GB) 0328467.6

(51) Int. Cl. B29C 45/02; B29C 33/20

(52) U.S. Cl. 425/562; 264/238; 29/428

(57) ABSTRACT

An injection valve attached to a mold insert, the injection valve including a valve nose body and the mold insert having a bore for receiving an end of the valve nose body, inserting the valve nose body into the bore of the mold insert and holding in position by means of a releasable locking mechanism.

### PRIOR APPLICATIONS

This application is a continuation-in-part of International Application No. PCT/GB2004/005178, filed on Dec. 9, 2004, which in turn bases priority on British Application No. 0328467.6, filed on Dec. 9, 2003.

### BACKGROUND OF THE INVENTION

1. Field of Invention

This invention relates to composite production by resin transfer molding.

2. Description of the Prior Art

The automation of composite molding production techniques requires control of two basic raw materials, i.e. the resin mix and the fiber pack. Automation of the resin transfer molding process thus involves the control of a two-stage production operation in which the fiber is first loaded into the mold and then, after the mold is closed, resin injection is effected.

The present invention is concerned with the second stage of the above process and, in particular, with the injection valve that controls the flow of mixed resin into the mold cavity. The injection valve has an inlet port and an outlet port, and it is opened by a control signal from the injection machine so as to allow the resin mix to flow into the mold until a predetermined volume has been injected. Upon completion of the injection cycle, the valve closes isolating the mold from the supply. The valve is then flushed through automatically, ready for the next injection cycle, and the cleaning fluid used for flushing purposes being discharged through a discharge port.

Installation of the injection valve is typically effected by attaching the outlet or nose of the injection valve to a mold insert fixture and then connecting the nozzle of the injection machine to the inlet port. A form of clamp is typically used to prevent the injection valve becoming separated from the mold insert fixture, the clamp acting on the rear of the injection valve to hold it in place while a seal on the front of the valve seals the valve outlet or nose to the mold fitting.

It is an object of the present invention to provide improvements in the apparatus and procedures described above.

A more specific object of the present invention is the provision of an improved method of, and means for, connecting the injection valve to the mold insert fixture.

A further object of the present invention is the provision of improved sealing means for the injection valve.

A valve may also be connected to a mold insert fixture for controlling the discharge of resin from a mold, and it is to be understood that, as used herein, the term “injection valve” includes any form of valve which is designed to be connected to a mold insert fixture and which incorporates flow control means.

### SUMMARY OF THE INVENTION

According to a first aspect of the present invention, there is provided a method of attaching an injection valve to a mold insert, the injection valve including a valve nose body and the mold insert including a bore for receiving an end of the valve nose body, the method including fitting the end of the valve nose body in the bore of the mold insert by means of a releasable locking mechanism.

The bore in the mold insert is preferably a stepped bore and the end of the valve nose body preferably includes a peripheral groove to receive a movable element of the locking mechanism.

The movable element of the locking mechanism may be a U-shaped spring clip, and the mold insert is preferably formed with slots to receive the arms of the U-shaped spring clip.

The end portion of the nose body may include a chamfered or inclined portion that engages the arms of the U-shaped spring clip to move them away from one another as the end of the nose body is inserted in the bore of the mold insert.

Possible alternative methods of holding the end of the valve nose body in position include the use of multiple clip fingers entering a plurality of slots, and the use of a cam lock that is rotatable between locking and unlocking positions.

According to a second aspect of the present invention, there is provided an injection valve that can be used in the method defined above in which the injection valve includes a pneumatic cylinder and a main valve body that has a threaded connection with a valve nose body. The pneumatic cylinder preferably contains a piston having a shaft that, at an end thereof remote from the cylinder, carries a seal. Operation of the piston and cylinder mechanism preferably results in movement of the piston from a position in which the injection valve is closed and the seal is in engagement with an opening in the valve nose body to a position in which the injection valve is closed and the seal is in engagement with an end of a tubular portion of the main valve body.

The piston is preferably urged by means of a spring into a position in which the injection valve is closed and is movable pneumatically into an open position.

According to a third aspect of the present invention, there is provided an injection valve that can be used in the method defined above, the valve being operable by means of a piston and cylinder mechanism in which the piston shaft is movable relative to a main valve body and the piston shaft is formed with a groove containing a PTFE sealing ring, and the main valve body included a sleeve that is formed of PTFE and is engaged by the PTFE sealing ring.

According to a further aspect of the present invention, there is provided an injection valve that can be used in the method defined above in which means are provided for flushing the interior of the valve after a resin injection operation using a cleaning fluid, and in which the cleaning fluid is caused to impinge on the rear of a seal that closed the port through which the resin is injected into the mold.

### BRIEF DESCRIPTION OF THE DRAWINGS

Further features and advantages of the present invention can be gathered from the following descriptions of the preferred embodiment with reference to the attached drawings, wherein:

FIG. 1 illustrates a sectional view of an injection valve of the present invention with the valve shown in its open position.

FIG. 2 illustrates a sectional view of the injection valve of the present invention with the valve in its closed position.

FIG. 3 illustrates a sectional view connecting the nose of the injection valve to a mold insert.

FIG. 4 illustrates a sectional view of FIG. 3 shown at right angles with one form of a clip that can be used for connecting the nose of the injection valve to the mold insert, the clip being in the locked position.

FIG. 4A illustrates a sectional view of FIG. 4 with the clip being in the unlocked position.

FIG. 5 illustrates a cross-sectional view of the clip of FIG. 4 shown in its locked position.

FIG. 5A illustrates a cross-sectional view of the clip of FIG. 4 shown in its unlocked position.

### DETAILED DESCRIPTION OF THE PREFERRED EMBODIMENT

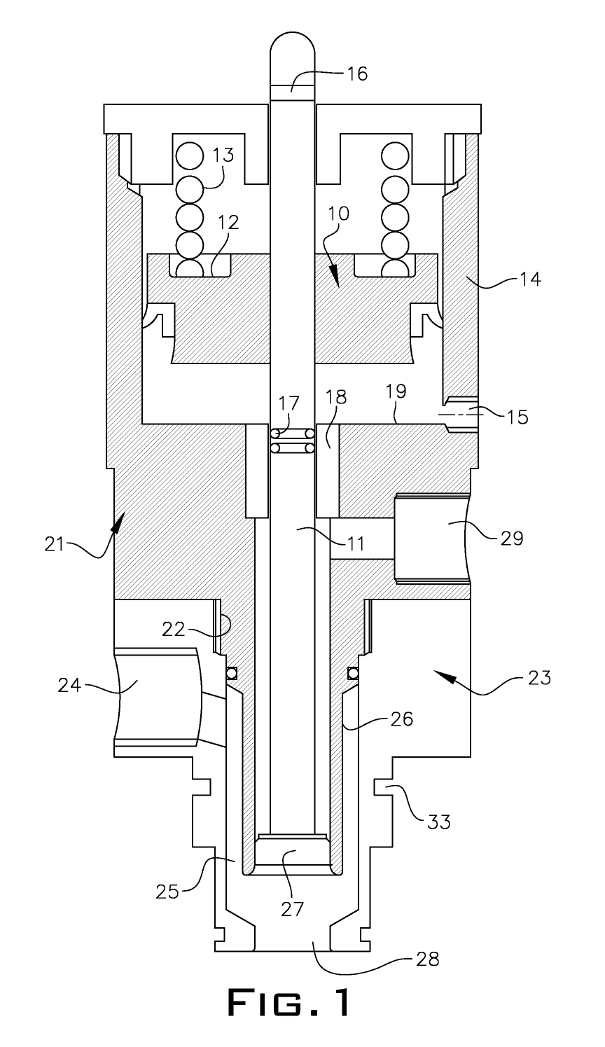

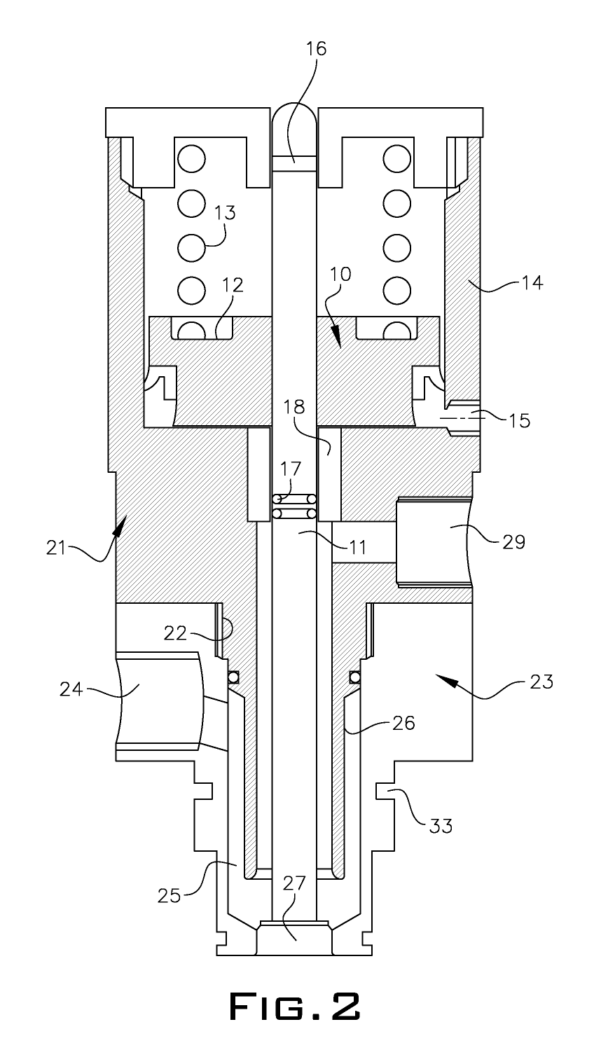

The injection valve shown in the drawings includes a pneumatically operated piston 10 having an elongated shaft 11. The piston 10 has a head 12 acted upon by a spring 13, and the piston head 12 is contained within a cylinder 14 into which air is introduced by an inlet 15 to displace the piston 10 upwardly from the closed position as shown in FIG. 2, and into the open position as shown in FIG. 1. At the upper end of the shaft 11 of the piston 10, there is a colored ring 16 that is readily visible when the valve is in its open position. The position of the colored ring 16 thus provides a visual indication of the open condition of the valve.

Limit switches may also be provided and, in such case, the shaft 11 will be extended so that it can operate both open and closed limit switches, thus providing remote position sensing.

The spring 13 provides for automatic closing of the injection valve when the supply of air power to the cylinder 14 is removed. The piston and cylinder mechanism is not double-acting and does not require a separate pilot valve to control its operation.

The cylinder 14 is typically a compact proprietary air cylinder and enables the dimensions of the valve as a whole to be small such that the valve can be fitted more easily to confined mold rear locations. The entire valve can be about half the size of currently available injection valves.

The shaft 11 is formed with a groove into which is fitted a sealing ring 17 being of PTFE and arranged for sliding engagement with a PTFE sleeve 18. The engagement of the sealing ring 17 with the sleeve 18 is such as to prevent the materials used for flushing out the resin mix and for cleaning purposes from passing upwardly into the cylinder 14.

This sealing arrangement is superior to those that have previously been employed for this purpose. Previous sealing arrangements have typically included two elastomeric “O” rings with grease filling the space between the two rings. The use of a PTFE sealing ring 17 that engages a PTFE sleeve 18 produces a lower coefficient of sliding friction and ensures that there is no progressive build-up of resin mix on the seal.

The base 19 of the cylinder 14 forms part of a main valve body 21 that has a downwardly extending threaded boss 22 and fits into a threaded socket of a valve nose body 23. The threaded connection of the main valve body 21 to the valve nose body 23 permits simple assembly of the components of the injection valve and facilitates disassembly for service purposes. This specific design has practical advantages as compared to existing injection valve designs that include four bolts for attaching the air cylinder to the main valve body and four further bolts for fixing the valve bodies together.

The valve nose body 23 includes a resin inlet 24 and resin flows, in operation, through the inlet 24 into an annular chamber 25 that surrounds a tubular portion 26 of the main valve body 21. A seal 27 is provided at the lower end of the shaft 11 and, when the injection valve is in its open position as shown in FIG. 1, the seal 27 engages the lower end of the tubular portion 26 to prevent the flow of resin into the interior of the tubular portion 26 while permitting the flow of resin through an opening 28 at the lower end of the valve nose body 23 into the mold cavity.

After the introduction of the resin mix into the mold cavity has been completed and the flow of resin through the resin inlet 24 has stopped, the injection valve is closed and, under the action of the spring 13 and the seal 27, is moved from the position shown in FIG. 1 into the position shown in FIG. 2 in which it closes the opening 28 leading to the mold cavity. When the valve is closed, a cleaning fluid is introduced into the annular chamber 25 through the resin inlet 24 so as to pass downwardly around the tubular portion 26, and then upwardly through the interior of the tubular portion 26 to a flush outlet 29 extending from the main valve body 21. The flow of cleaning fluid is directed over the rear of the main nose seal 27 so as to clean the seal 27 very efficiently and to ensure that there can be no sediment collection afforded by mixed resin against the rear of the seal 27. This extends the service life of the nose seal as compared to previous nose and seal designs.

As shown in FIGS. 1-3, the resin inlet 24 has its port entry so arranged that the flow of resin is inclined downwardly and at a slight tangent to the outer flow annulus. This provides a spiral feed that aids self-purging as the resin passes to the outlet mold port or when the valve is closed, spirals downwards and then upwards to the drain port or outlet 29. This increases cleaning efficiency after injection.

It is to be noted that the valve main seal 27 can be serviced from the mold face without a requirement to remove the valve nose body 23 from the mold 31. This facility is achieved by unscrewing the main valve body 21 and then holding the seal 27 with a small hexagon slotted fixing screw on the external nose face that centrally clamps the sleeve 18 on the piston shaft 11. Removal and replacement of the seal 27 involves un-tightening the screw with a hexagon key and sliding the seal off the screw, followed by replacement with a new seal and re-tightening of the screw. Removal and replacement of a seal 27 will take, at most, ninety seconds, and this represents a major service improvement as compared to previous injection valve designs.

It is also to be noted that the details of the seal 27 and its fixing screw are such that when installed they present a surface that is flush with the end face of the valve nose body 23, and do not impede the creation of a flush molding surface in the mold cavity at the valve inlet when the injection valve is closed.

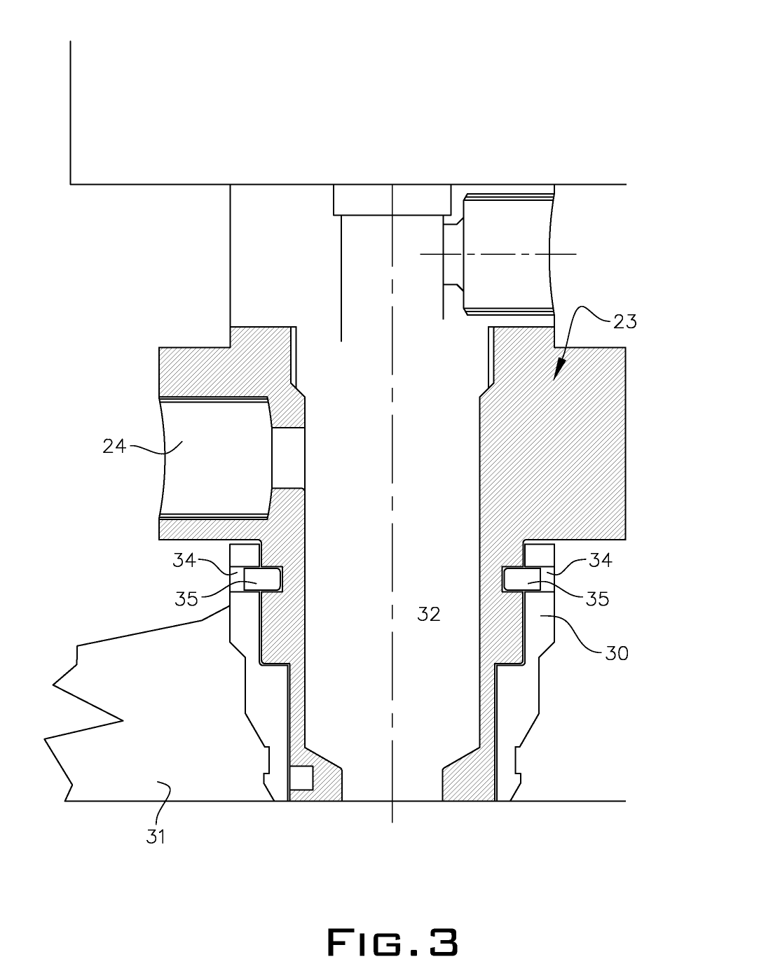

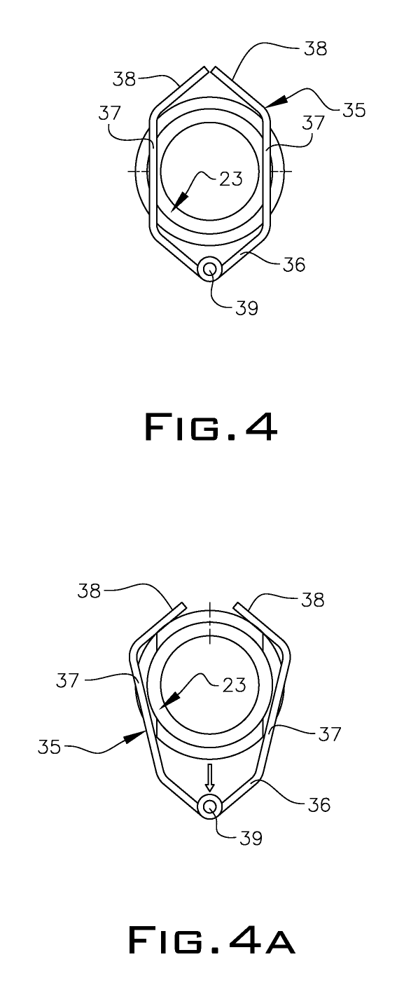

Fitting of the lower end of the valve nose body 23 in a mold insert 30 of a mold 31 is illustrated in FIG. 3. The lower end portion of the valve nose body 23 typically has an external diameter of 20 mm, and an adjacent portion 32 of the valve nose body has an external diameter of 25 mm. A peripheral groove 33 (see FIG. 4) is formed in the adjacent portion 32 of the valve nose body 23. The base of the groove 33 typically has a diameter of 20 mm, and the groove 33 is located 20 mm from the lower face of the valve nose body 23. The insert 30 is made of metal, has a length of 25 mm, and has a stepped bore with internal diameters of 20 mm and 25 mm. At a rear position of the insert 30 and 20 mm from the lower face of the insert, two horizontal slots 34 are machined in the insert 30, the slots 34 having a depth of 2 mm and being positioned in register with the peripheral groove 33.

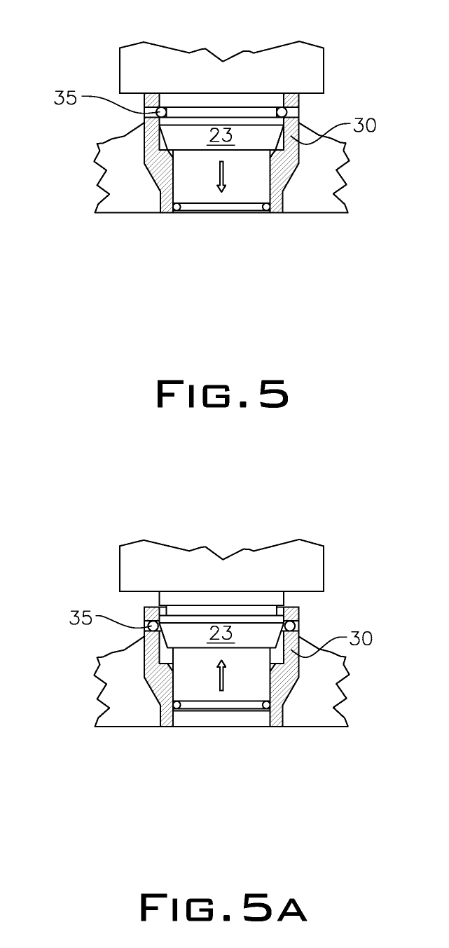

When the valve nose body 23 of the injection valve is inserted fully in the stepped bore of the insert 30, the groove 33 is aligned with the slots 34. A close-fitting 2 mm, generally U-shaped, spring clip 35 is positioned in the slots 34 and enters the groove 33 so that the clip 35 is positioned in the slots 34, and enters the groove 33 so that the clip 35 occupies the position shown in FIG. 4. The valve nose body 23 is locked releasably in position within the bore of the mold insert 30 by means of the spring clip 35, which as a base 36 and a pair of arms 37 that extend into turned-in end portions 38. The base 36 of the spring clip 35 includes a ring portion 39. To remove the valve nose body 23 from the insert 30, the user moves the spring clip 35 by engaging the ring portion 39 by means of a suitable tool (not shown) displacing the clip 35 from the closed position shown in FIG. 4 into the open position shown in FIG. 4A. The injection valve is then moved upwardly to move the valve nose body 23 from the position shown in FIG. 5 into the position shown in FIG. 5A. It is noted that removal of the spring clip 35 is not necessary, but merely to move it from the closed position (see FIG. 4) to the open position (see FIG. 4A).

Engagement of the arms 37 of the U-shaped clip 35 in the groove 33 at positions either side of the axis of the valve nose body 23 ensures that the valve nose body 23, and the injection valve as a whole, is held securely in engagement with the mold insert 30 and mold 31 by means of a locking mechanism that is able to withstand injection mold pressures well above any that are likely to be experienced in practice.

As shown in FIGS. 5 and 5A, the end portion of the nose body 23 includes a chamfered or inclined portion that engages the arms 37 of the U-shaped spring clip 35 to move them away from one another as the end of the nose body 23 is inserted in the bore of the mold insert 30, until a position is reached in which the arms 37 of the clip 35 are in register with the groove 33 and move resiliently inwardly into locking engagement in the groove 33.

Other possible methods of holding the end of the valve nose body 23 in position within the mold insert 30 include, but are not limited to, the use of multiple clip fingers entering a plurality of slots and the use of a cam lock that is rotatable between locking and unlocking positions.

1-14. (canceled)

15. An injection valve for use in resin transfer molding, the injection valve comprising:
a piston and cylinder mechanism in which a piston shaft is adapted to move relative to a main valve nose body;
the valve nose body attached to a mold insert having a bore adapted to receive an end of the valve nose body with a releasable locking mechanism;
the mold insert having slots adapted to receive the arms of a U-shaped spring clip; and
an end of the injection valve nose body having a peripheral groove adapted to receive a movable element in the locking mechanism.

16. The injection valve according to claim 15, wherein the mold insert bore is stepped.

17. The injection valve according to claim 15, wherein the piston shaft is formed with a groove containing a PTFE sealing ring and the valve nose body includes a sleeve formed of PTFE and is engaged by the PTFE sealing ring.

18. The injection valve according to claim 15, wherein a means for flushing an interior portion of the valve after a resin injection impinges on a rear portion of a seal that closes a port through which the resin is injected into a mold.

19. The injection valve according to claim 18, wherein a resin inlet is adapted to cause a flow of resin to spiral downwardly into the interior of the valve.

20. An injection valve for use in resin transfer molding, the valve attached to a mold insert, the valve and mold insert combination comprising:
the injection valve having a valve nose body;
the mold insert having a bore adapted to receive an end of the valve nose body with a releasable locking mechanism;
the bore in the mold insert being stepped;
the mold insert having slots adapted to receive the arms of a U-shaped spring clip; and
an end of the injection valve nose body having a peripheral groove adapted to receive a movable element in the locking mechanism.

21. A method of attaching an injection valve to a mold insert, the steps of the method comprising;
providing a piston and cylinder mechanism in which a piston shaft moves relative to a main valve nose body;
providing a mold insert having a bore;
inserting an end of the valve nose body into the bore with a releasable locking mechanism;
providing a peripheral groove in the end of the valve nose body to receive a movable element of the locking mechanism; and
providing the movable element as a U-shaped spring clip inserted into a slot in the mold insert.

22. The method according to claim 21, wherein the movable element is provided as a pair of U-shaped spring clips inserted into opposed slots in the mold insert.

23. The method according to claim 21, wherein the piston is moved from a position in which the injection valve is closed and a seal is in engagement with an opening in the valve nose body to a position in which the injection valve is closed and the seal is in engagement with an end of a tubular portion of the valve body.

24. The method according to claim 23, wherein a spring urges the piston into a position in which the injection valve is closed.
